(19) United States
(12) Patent Application Publication
(10) Pub. No.: US 2008/0001847 A1
(43) Pub. Date: Jan. 3, 2008

(54) System and method of using a multi-view display

(76) Inventors: Daniela Kratchounova, Savannah, GA (US); Stephen F. Landers, Rincon, GA (US); Ronald Albert Newton, Richmond Hill, GA (US)

Correspondence Address: BRANDON N. SKLAR. ESQ. (PATENT PROSECUTION);KAYE SCHOLER, LLP, 425 PARK AVENUE, NEW YORK, NY, 10022-3598, US

(21) Appl. No.: 11/648,567

(22) Filed: Feb. 1, 2007

Related U.S. Application Data
(60) Provisional application No. 60/817,748, filed on Jun. 30, 2006.

(51) Int. Cl. G09G 5/00

(52) U.S. Cl. 345/1.1

(57) ABSTRACT

Embodiments of the invention relate to a vehicle instrumentation systems and display systems employing multi-view displays in various land, water, air, and/or space vehicles. In one embodiment of the invention, an aircraft instrumentation system for a flight deck instrument panel includes at least one multi-view display configured to display at least two views, associating one view with a first crew member and the other view with a second crew member. In another embodiment of the invention, a standby instrument may be displayed on each of two multi-view displays such that a standby instrument is visible to each crew member at all times during aircraft operation.

This application claims priority to co-pending U.S. Provisional Patent Application 60/817,748, filed Jun. 30, 2006, and entitled “Aircraft Systems Using Multi-View Displays,” which is hereby incorporated by reference in its entirety.

### FIELD OF THE INVENTION

This invention relates to vehicle display systems and, more particularly, to instrument panels or control display systems employing multi-view displays.

### BACKGROUND OF THE INVENTION

Control systems and instrumentation panels for modern vehicles, such as, for example, armored vehicles, tanks, aircraft, and spacecraft, include advanced computer electronics and displays systems. Modern aircraft, for example, employ advanced instruments and display systems, often including large displays, measuring up to 14 inches by 10 inches (about 35.5 cm by about 25.4 cm). Further, many modern aircraft may use multiple large displays, in some cases numbering four or more displays for a large passenger aircraft. As such, flight deck space has become increasingly scarce, forcing the large displays to multi-task, for example, presenting various menus and functional information depending on the flight condition and preferences of the pilot. These large displays are commonly referred to in the aerospace industry as Multi-Functional Displays (“MFDs”).

Some MFDs, typically those substantially in front of the pilot or copilot, are programmable and/or customizable and are used by the pilot as the primary instrument or display for flying the aircraft. These displays are commonly referred to as the Primary Flight Displays (“PFDs”) and are assigned or dedicated to the pilot or copilot. MFDs and PFDs typically include a separate controller, including knobs, buttons, and the like, to select different menus and graphical presentations of information on the displays. Additionally, the flight deck instrument panels include individual controllers for specific aircraft systems, such as the fuel system, the electrical power system, weather detection system, etc., which further crowd and complicate the flight deck instrument panel.

Despite the reliability of modern aircraft electronics and electronic displays, safety features and redundant systems are still provided by aircraft manufacturers and, in some cases, are required by Federal Aviation Rules (FAR). For example, according to FAR 25.1333(b): “The equipment, systems, and installations must be designed so that one display of the information essential to the safety of flight which is provided by the instruments, including attitude, heading, airspeed, and altitude will remain available to the pilots, without additional crewmember action, after any single failure or combination of failures that is not shown to be extremely improbable.” In addition, FAR 25.1303(b)(4) states that: “A gyroscopic rate-of-turn indicator combined with an integral slip-skid indicator (turn-and-bank indicator) except that only a slip-skid indicator is required on large airplanes with a third attitude instrument system useable through flight attitudes of 360° of pitch and roll and installed in accordance with § 121.305(k) of this title.” The display that must remain available to the pilots during failures is referred to in the industry as a standby indication, instrument, or display. To meet these regulations, one standby display is typically mounted on the instrument panel between the pilot and copilot.

The expanded use of large MFDs and PFDs on the flight deck control panel leaves little space for placement of other instrumentation. This is especially true for the traditional placement of the standby display in the center, between the pilot and copilot, on the flight deck control panel. While this center location meets the visual requirements of FAR 25.1321 (a), (b), (1), (2), (3), and (4), most aircraft manufacturers now consider this center location ideal for additional large MFDs or other instruments.

Furthermore, the lack of space on the flight deck instrument panel, the complexity added by the increased level of automation, and the high performance of modern aircraft may place extra workload on aircraft pilots. Although large MFDs help pilots efficiently manage the workload, the aircraft pilots must scan instruments, gather vital information, and manage to fly the aircraft simultaneously. In some cases, such as during emergencies and/or certain aircraft maneuvers, the standby display may be the only instrument available to the pilots. The traditional placement of the standby display places the standby display outside of the Primary Field of View as regulated by DOT/FAA/CT-96/1 Human Factors Design Guide. This forces the pilot to perform different instrument scans to locate and gather necessary information from the standby display, which inherently intensifies the already heavy pilot workload during an emergency.

Conditions requiring the pilot to scan along multiple axes, such as vertical and horizontal, during an instrument scan are referred to by those of skill in the art as parallax. As known by those of skill in the art, parallax conditions during flight, and especially during emergency conditions, significantly increases the pilot's workload and level of stress.

Although previous attempts have been made to relocate the traditional standby instrument from the center of the instrument panel, they have not been successful. For example, space for standby instrument installation may be found on the far sides of the instrument panel. This position, however, fails to comply with the visibility and access requirement of Federal flight regulations for both pilots, forcing the use of multiple standby displays in order to meet flight regulations. Furthermore, such positioning does not address the increased workload applied to pilots during instruments scans, especially since any scan of a standby display in this position creates a parallax condition.

Likewise, placement of the traditional standby instrument above the PFD has been equally unsuccessful. The region of the instrument panel above the PFD has traditionally been extremely crowded with avionics instruments necessary to display various flight data and control aircraft systems. Although the traditional standby instrument is a critical device in emergencies, the traditional standby instrument is not otherwise used very often. As such, placing the rarely-used traditional standby instrument among the highly used displays and controllers above the PFD has been previously considered operationally costly and inefficient.

### SUMMARY OF THE INVENTION

In accordance with some embodiments of the invention, a multi-view technology may be employed in vehicles having displays systems, such that a single display device may function as two simultaneous displays. The single display device may be configured with two different viewing envelopes. Each viewing envelope defines a three-dimensional space within which an associated image on the display device is visible. By employing the multi-view technology in accordance with embodiments of the invention, a vehicle may significantly increase the effective display space by dedicating a first image, and associated viewing envelope, with a first crew member and dedicating a second image, and associated viewing envelope, with a second crew member.

For example, an aircraft instrumentation panel, employed on a two pilot aircraft, may include a display device employing multi-view technology, capable of providing two different images, one to each pilot. To accomplish this, each pilot may be positioned within a different viewing envelop to the display device, as discussed in ARP4256 (Design Objectives for Liquid Crystal Displays for Part 25) and ARP4260 (Photometric and Colorimetric Measurement Procedures for Airborne Flat Panel Displays). Some embodiments of the invention may be used to meet compliance with FAR regulations, more specifically FAR §91.205, §25.1303, § 25.1321 and §25.1333, by always displaying the standby instrument on at least one of the two images on a multi-view display.

In one embodiment of the invention, two multi-view displays may be employed with any associated aircraft system controller that combines multiple functions into a single device. To maximize instrument panel real estate and minimize pilot workload while maintaining compliance with FAR regulations, multifunctional instruments (system controllers and displays), combined with standby instruments, may be used as discussed in one embodiment disclosed in U.S. patent application Ser. No. 11/172,925, filed Jul. 5, 2005, which is assigned to the assignee of the present invention and hereby incorporated by reference in its entirety. By combining the multi-view technology into the multifunction controllers and associated displays, each associated display may function to display two images, one in each of two different viewing envelopes. For each display, the two images may be referenced as an on-side image or view and a cross-side image or view. The on-side view may be associated with a viewing envelope directed at the side of the aircraft that the display is installed on and a cross-side view may be associated with a viewing envelope directed at the side of the aircraft opposite of the display. Each on-side view may be controlled by an associated crew member or pilot, located in the associated viewing envelope, to access information from the various data sources. Each cross-side view may be controlled by another crew member or pilot, located in the associated viewing envelope, or may be configured to always display the standby indications, thereby satisfying FAR regulations concerning the standby instruments.

These and other objects and advantages of the invention will be apparent from the following description and the accompanying drawings.

### BRIEF DESCRIPTION OF THE DRAWINGS

FIG. 1 is a schematic functional view of a multi-view display according to an embodiment of the invention;

FIG. 2 is a schematic front view of a flight deck according to an embodiment of the invention;

FIG. 3 is a schematic top view of a multi-view display arrangement according to an embodiment of the invention;

FIG. 4 is a view of a display/controller displaying an example of a standby instrument on a cross-side view of a multi-view display according to an embodiment of the invention;

FIG. 5 is another view of the display/controller of FIG. 4 displaying an example of a menu option on an on-side view of a multi-view display according to an embodiment of the invention; and

FIG. 6 is another schematic top view of a multi-view display arrangement in accordance with an embodiment of the invention.

### DETAILED DESCRIPTION OF THE INVENTION

The present disclosure will now be described more fully with reference to the Figures in which various embodiments of the present invention are shown. The subject matter of this disclosure may, however, be embodied in many different forms and should not be construed as being limited to the embodiments set forth herein.

In accordance with embodiments of the invention, vehicle display systems and instrument panels may be configured with multi-view displays in order, for example, to maximize the limited space available to multi-crew member vehicles. These vehicles may include, but should not be limited to, tanks, armored vehicles, ships, submarines, aircraft, and spacecraft.

In an illustrative example of some embodiments of the invention, an aircraft instrument panel display may be configured to employ a multi-view display in order, for example, to maximize instrument panel real estate, reduce crew workload, minimize additional training, eliminate the addition of new operating procedures, reduce the total number of line-replaceable-units (LRUs) making the installation potentially less expensive, provide additional layer of display redundancy, and/or provide greater flexibility to the pilots in customizing their instrument panels. A multi-view display, such as the dual-view LCD display manufactured by Sharp Corp., may provide two different images in two different viewing envelopes. Embodiments of the invention may include displaying operational information or flight data to two pilots using a single display device, effectively doubling the functionality of a single display device. Although embodiments shown in the figures relate to displays with two viewing envelopes, such as the dual-view display by Sharp Corp., it is contemplated that implementations of the invention may include multi-view devices that include more that two views and may be configured to provide operational information or flight data to more than two crew members.

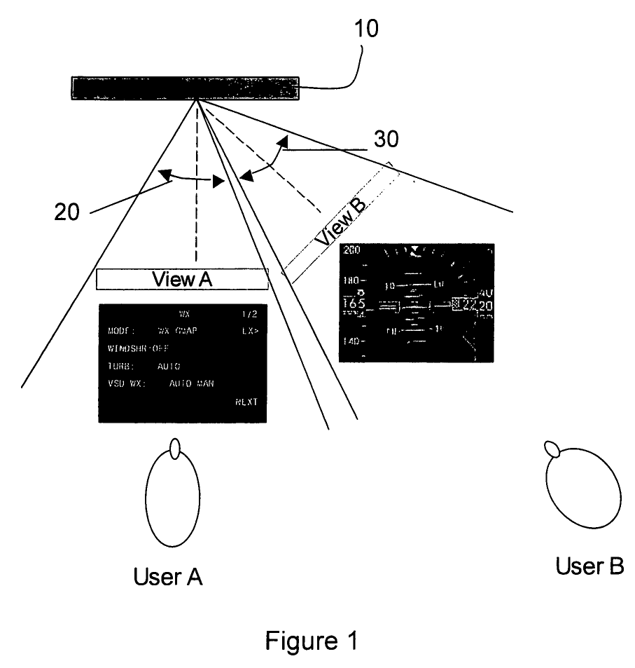

FIG. 1 schematically illustrates an example of the functional capability of a multi-view display 10 in accordance with an embodiment of the invention. As shown in FIG. 1, the multi-view display 10 projects a view A and a View B within different viewing envelopes. The multi-view display 10 shows the view A to the User A (for example, the pilot) so long as the User A is located within the viewing envelope 20. Likewise, the multi-view display 10 shows the view B to the User B (for example, the copilot) so long as the User B is located within the viewing envelope 30. It should be understood that the viewing envelopes may be adjusted in size and position. Although the viewing envelopes 20 and 30 are shown in two dimensions in FIG. 1, one of ordinary skill would understand that the viewing envelopes represent three dimensional volumes.

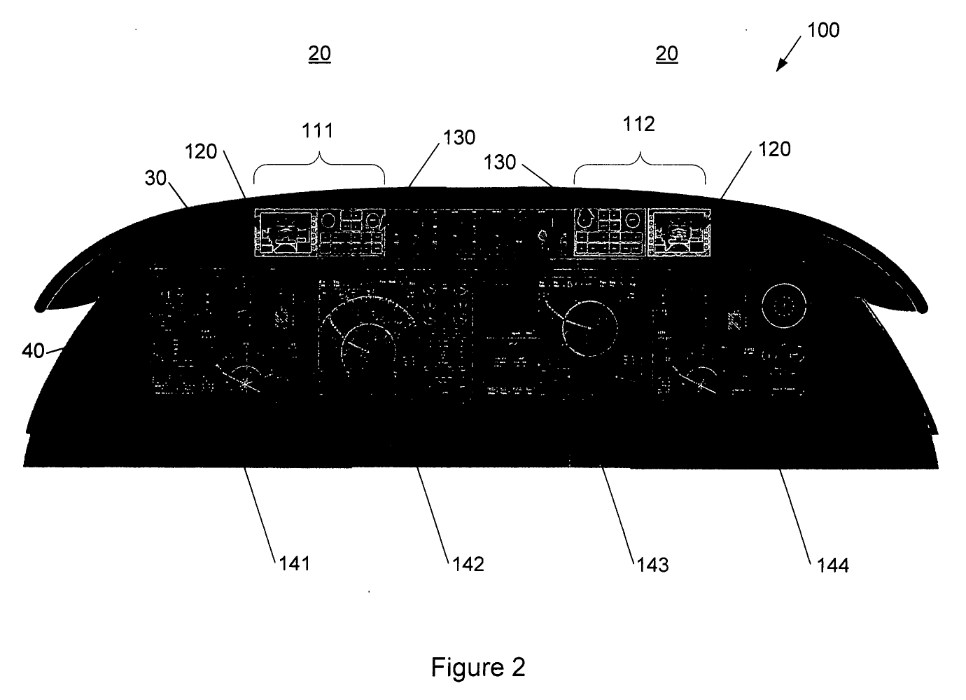

FIG. 2 schematically shows an example of a front view of aircraft flight deck instrumentation 100 in accordance with embodiments of the invention where multi-view displays may be used to increase the functionality of the instrumentation and meet compliance with FAR regulations. The flight deck instrumentation 100 includes a windshield window area 20, a glare shield 30 and a main instrument panel 40. The flight deck instrumentation 100 also includes two display and configurable controllers 111 and 112, hereafter referred to as display/controllers 111 and 112. The flight deck instrumentation 100 also includes four multi-function displays (“MFDs”), shown in FIG. 2 as MFDs 141, 142, 143, and 144. Each display/controller 111 and 112 includes a display 120 and a companion controller panel 130 and may be associated with a pilot or copilot and one or more of the MFDs.

Although the display/controllers 111 and 112 may be configured such that they are associated with any of the MFDs 141, 142, 143, and 144, the display/controllers 111 and 112 may be associated with the MFDs mounted directly beneath. For example display/controller 111 may be associated with MFDs 141 and 142. It is also contemplated that the display/controllers may be associated with fewer or more MFDs. Further, the display/controllers 111 and 112 are shown in FIG. 2 as being positioned in the glare shield 30 and directly above the MFDs 141, 142, 143, and 144, however, the display controllers 111 and 112 may also be positioned elsewhere on the flight deck instrumentation 100. Likewise, other instruments, such as the MFDs 141, 142, 143, and 144, may be otherwise positioned on the flight deck instrumentation 100. The size and number of the displays shown in FIG. 2 may be changed and adjusted without deviating from the scope and spirit of the invention.

In accordance with one embodiment of the invention, multi-view displays may be incorporated into the display/controllers 111 and 112 such that a standby instrument may be displayed on the cross-side views of both display/controllers at all times. By always providing the standby indications on the cross-side views of the display/controllers 111 and 112, the display/controllers 111 and 112 may be configured and programmed to satisfy the regulatory requirements for redundant, backup flight displays. For example, the combination of FAR 14 CFR Ch. 1 paragraphs 25.1303, 25.1321, and 25.1333 requires that a standby instrument be visible and remain available by both the pilot and copilot at all times without additional crewmember action. Paragraph 25.1321 also requires that the standby instrument (a) be plainly visible to the pilot from the pilot's station with minimum practicable deviation from his normal position and line of vision when the pilot is looking forward along the flight path; (b) display (1) attitude in the top center position, (2) airspeed instrument adjacent to and directly to the left of the attitude, (3) altitude instrument adjacent to and directly to the right of the attitude, and (4) direction of flight instrument adjacent and directly below the attitude. As would be apparent to those of skill in the art, the instrument panel 100 and the display/controllers 111 and 112 may be configured using the multi-view displays to meet other required flight regulations, for example FAR §91.205.

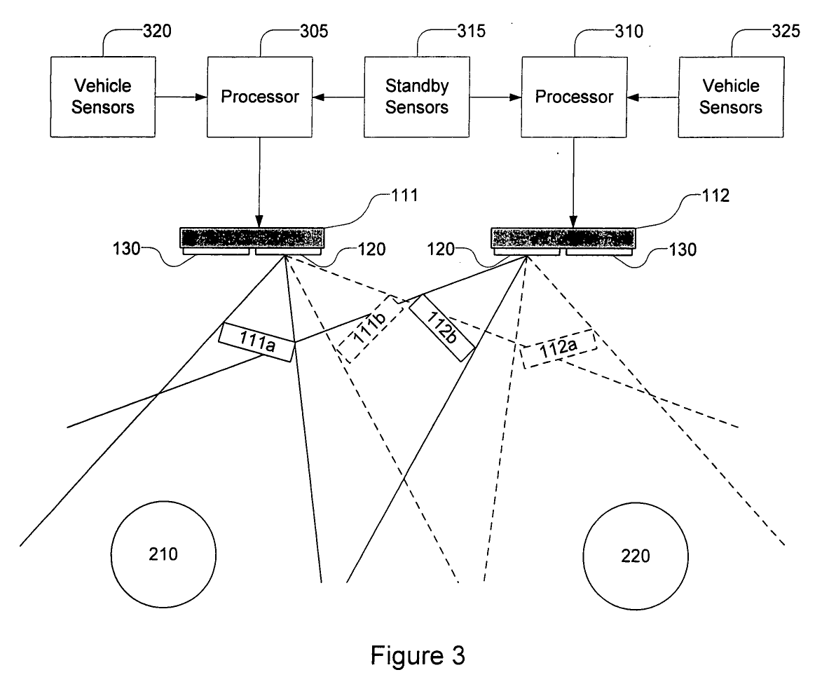

FIG. 3 schematically illustrates an embodiment of the invention with multi-view displays configured on the display/controllers 111 and 112. FIG. 3 also illustrates the viewing envelopes available for a pilot and copilot with regard to the display/controllers 111 and 112 and the multi-view displays 120. The multi-view display 120 of display/controller 111 may be configured, as shown, to display an on-side view 111a and a cross-side view 111b. The on-side view 111a of display/controller 111 is associated with the pilot 210 and the cross-side view 111b of display/controller 111 is associated with the copilot 220. Likewise, the multi-view display 120 of display/controller 112 may be configured, as shown, to display an on-side view 112a and a cross-side view 112b. The cross-side view 112b of display/controller 112 is associated with the pilot 210 and the on-side view 112a of the display/controller 112 is associated with the copilot 220.

As envisioned for a two pilot aircraft, the pilot and copilot may control their on-side views 111a and 112a, respectively, using the controllers 130 in order to configure instrument panel displays and control various aircraft systems (both on ground and in air). The on-side views 111a and 112a may therefore be customized and configured without restrictions or any effect on the cross-side views 111b and 112b. The cross-side views 111b and 112b may be configured to display the standby indications at all times. The on-side and cross-side views may be reversed such that the on-side views show the standby indications at all times and the cross-side views are configurable by the pilot and copilot.

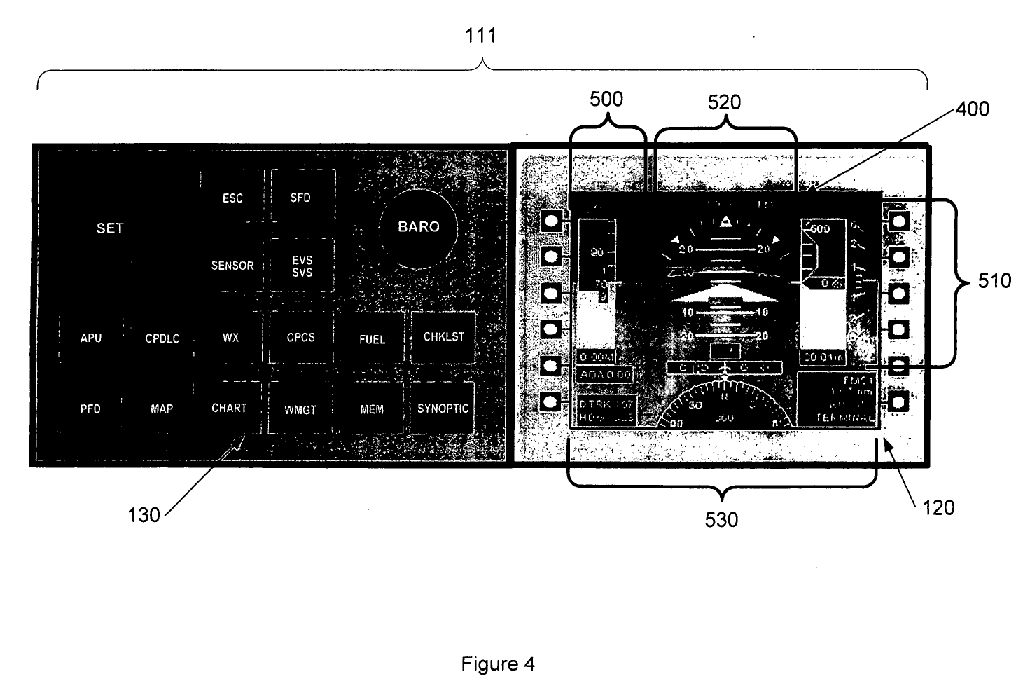

In FIG. 4, the display/controller 111 of FIG. 3 is schematically shown with an example of a standby instrument on the cross-side view of the multi-view display 120. FIG. 4 illustrates the display 120, which includes a screen 400, configured to show standardized flight data in compliance with a standby instrument.

In accordance with one embodiment of the invention, the cross-side view 111b of the display/controller 111, shown in FIG. 4, operates as the standby instrument for the copilot 220 (shown in FIG. 3). It should be understood that the illustration of the standby instrument shown in FIG. 4 may apply to both display/controllers 111 and 112. Consequently, the cross-side view 112b of display controller 112 may also display the standby instrument shown on the display 120 in FIG. 4 and may be used as the standby instrument for the pilot 210 (shown in FIG. 3).

As one of ordinary skill in the art would recognize, the standby instrument flight data shown in FIG. 4 generally pertains to flight data regarding airspeed, altitude, attitude, and heading. In accordance with FAR regulatory requirements, the display/controllers 111 and 112 may be configured as shown in FIG. 4 in which the cross-side views 111b and 112b display specific aircraft data. For example, the airspeed 500 may be shown on the left of the screen 400. Altitude data 510 may be displayed on the right with attitude data 520 generally shown between the altitude data 510 and the airspeed data 500. Along the bottom of the screen 400, as an example, the heading data 530 may displayed. It should be understood that the standby instrument may be configured to display this or other flight data in different configurations with more or less flight data shown. Although the data shown in FIG. 4 may be configured to satisfy some FAR regulations, other configurations of flight data may be configured to the pilot's preference or for compliance with alternative regulations, such as, for example, those of foreign countries.

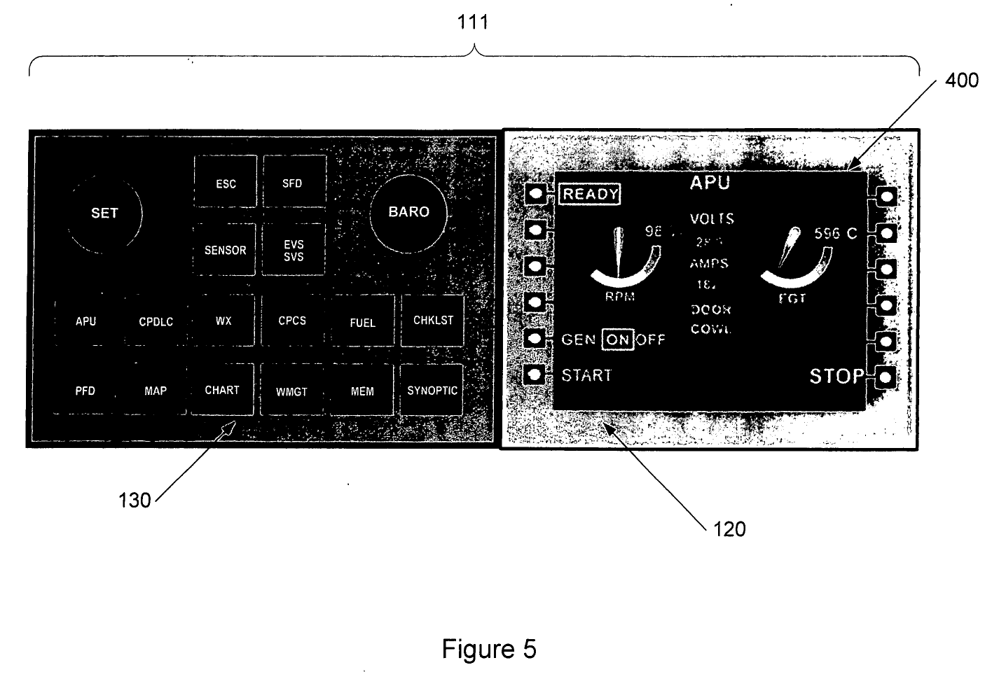

In FIG. 5, the display/controller 111 is schematically shown with the display 120 displaying an example aircraft system menu on the on-side view 111a. As shown, the on-side view includes an aircraft power menu on the on-side view of screen 400. As would be apparent to those of skill in the art, the display 120 and the on-side view may be configured to display any number of aircraft system menus, flight information, standby indications, etc. The controller 130 may be used to navigate the menus shown on the display 120 or control other displays or instruments.

The control panel 130 of the display controllers 111 and 112 may function in concert with the display 120 to display aircraft system data and make changes to an aircraft system. The panel 130 may also operate independently of the display 120. For example, it is contemplated that changes may be made to aircraft systems using the panels 130 without disturbing the on-side or cross-side views of displays 120.

Returning to FIG. 3, a processor 305 and a processor 310 may be configured to provide image data to the display/controllers 111 and 112. More specifically, the processor 305 may be configured to operate in concert with the controller 130 and/or the multi-view display 120 of the display/controller 111 to provide image data for the on-side view 111a and the cross-side view 111b. Likewise, the processor 310 may be configured to operate in concert with the controller 130 and/or the multi-view display 120 of the display/controller 112 to provide image data for the on-side view 112a and the cross-side view 112b. The processor 305 may monitor or receive aircraft data from the aircraft sensors 320 and process the aircraft data for display, for example, as shown in FIG. 5. The processor 305 may also work in concert with the controller 130 to control the aircraft subsystems. As a form of redundancy, the processor 310 may monitor or receive aircraft data from an additional set of aircraft sensors 325 and process the aircraft data for display.

As standby instruments typically include their own separate power source, independent data sources and independent displays, the processor 305 may be configured to monitor or receive standby data from the separate standby sensors 315. Similarly, the processor 310 may monitor or receive standby data from the separate standby sensors 315. In accordance with one embodiment of the invention, the processor 305 may use the standby data and provide image data to the display/controller 111 such that the standby instrument is displayed on the cross-side view 111b to the copilot 220. Further, the processor 310 may use the standby data and provide image data to the display/controller 112 such that the standby instrument is displayed on the cross-side view 112b to the pilot 210. Two separate standby sensors could be used such that each processor 305 and 310 includes dedicated standby sensors.

In an embodiment where the pilot 210 is permitted to control the image shown on the cross-side view 112b, the processor may also be coupled to the display/controller 112. Likewise, the processor 310 may be coupled to the display/controller 111. Although not shown, it is also contemplated that a single processor in conjunction with various aircraft sensors (standby and otherwise) may be used to control both display/controllers 111 and 112. As would be apparent to those of skill in the art, other combinations of processor and sensors may be used in various combinations to provide different levels of system redundancy.

Additional levels of redundancy may be supplied by the instrumentation 110. For example, the loss of a single display/controller may result in the other display/controller being designated as the regulatory standby instrument for both pilot and copilot, forcing the operating display/controller to display the standby instrument on both the on-side and the cross-side views at all times. More specifically, in the event display/controller 111 is lost, display/controller 112 may be designated as the standby instrument, displaying on both the on-side view 112a and the cross-side view 112b the standby indications as shown in FIG. 3. In such a situation, the control features and functions of the controller 130 and the display 120 of both display/controllers 111 and 112 may need to be handled by an alternative instrument. To accomplish this, the functions provided by the control panel 130 and the displays 120 of the display/controllers 111 and 112 may also be supported and/or controlled by other means in the flight deck as a form of redundancy for the cockpit instrumentation 100.

Therefore, by combining the multi-view displays shown in FIG. 3 with the cross-side configuration shown in FIG. 4 and the on-side configuration shown in FIG. 5, the multi-view display 120 of display/controller 111 may be configured to function such that the on-side view 111a may be viewed and operated freely by the pilot 210 while the copilot 220 simultaneously views the standby instrument in the cross-side view 111b at all times. Likewise, the multi-view display 120 of display/controller 112 may be configured to function such that the on-side view 112a may be viewed and operated freely by the copilot 220 while the pilot 210 simultaneously views the standby instrument, as shown on the display in FIG. 4, in the cross-side view 112b at all times. This configuration, in accordance with one embodiment of the invention, provides compliance with FAR regulations regarding standby instruments without affecting the functioning of the controller 130 and the on-side view of the display 120 of each display/controller 111 and 112 as conventional display/controllers.

Although regulatory requirements necessitate the presence of a standby instrument that satisfies the various FAR requirements, it is not required that the standby instrument be incorporated into the display/controllers 111 and 112. The on-side views 111a and 112a and the cross-side views 111b and 112b may be configured as operational displays for aircraft system menus, display of aircraft flight data, or otherwise configurable according to the preferences of the pilot or copilot. The standby instrument may be placed on other displays 141, 142, 143, and 144, or on other instruments in the cockpit.

Also, various combinations of display of the standby instrument and customizable images may be employed on the multi-view displays of the display/controllers, allowing full control of both on-side and cross-side views of the display controllers. For example, the on-side views and the cross-side views may be used to display other operational flight data or aircraft system menus until a system failure occurs, whereby the on-side and/or cross-side views would automatically revert to a standby instrument. Additionally, it should be understood that the on-side views and cross side views may initially default to the standby instrument until the pilot or copilot overrides the default with preferences for other operational flight data. As such, it should be understood that the multi-views of the displays 120 of the display/controllers 111 and 112 may be configured to display alternative flight information without deviating from the scope and spirit of the invention.

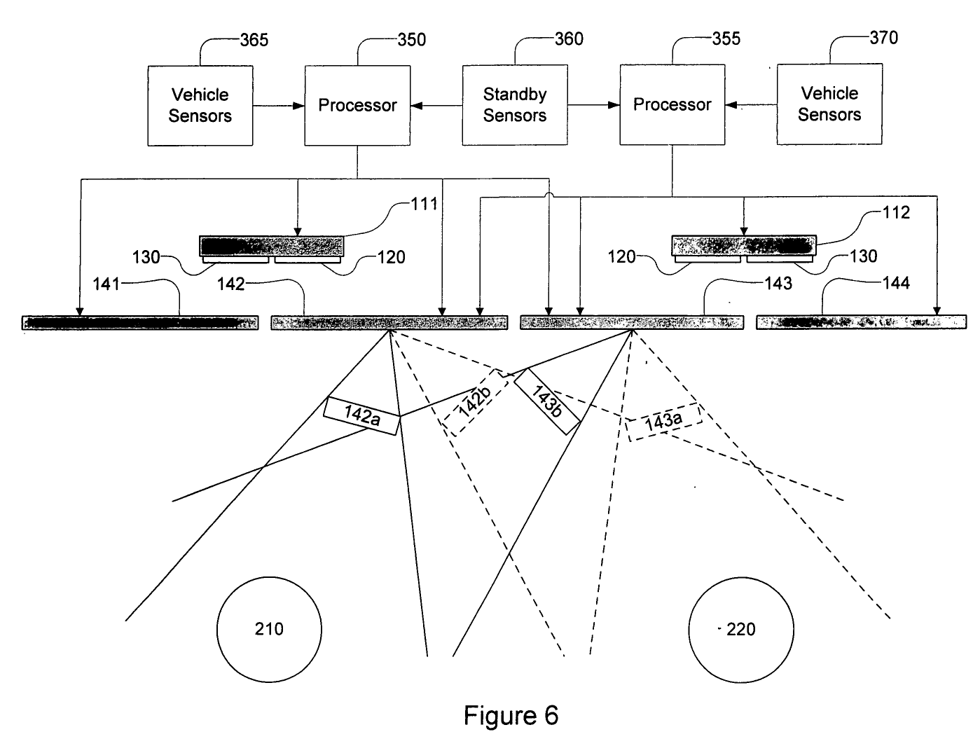

In accordance with another embodiment of the invention, the MFDs 141, 142, 143, and 144, shown in FIG. 2, may include multi-view displays. Multi-view displays may be used on the MFDs in addition to or instead of using multi-view displays on the displays 120. FIG. 6 schematically illustrates one embodiment of the invention wherein multi-view displays are incorporated into MFDs 142 and 143 of the instrumentation 100. As with the displays 120 discussed above, the MFD 142 includes an on-side view 142a, associated with the pilot 210, and a cross-side view 142b, associated with the copilot 220. Likewise, the MFD 143 includes an on-side view 143a, associated with the copilot 220, and a cross-side view 143b, associated with the pilot 210.

As shown in FIG. 6, the pilot 210 may configure three MFDs 141, 142 (with on-side view 142a), and 143 (with cross-side view 143b) to display operation aircraft data, effectively increasing the display area of the conventional two pilot-associated MFDs, as discussed with reference to FIG. 2, to three pilot-associated MFDs. Likewise, the copilot may configure three MFDs 144, 143 (with on-side view 143a), and 142 (with cross-side view 142b) to display operational aircraft data, effectively increasing the display area of the conventional two copilot-associated MFDs, as discussed with reference to FIG. 2, to three copilot-associated MFDs.

Further, the images displayed on the associated MFDs may be customized per the preferences of the pilots. For example, the pilot may have the MFD 142a configured to display a moving map and 143b to display an approach chart. The copilot may configure 142b to display the approach chart, and 143a to display the moving map.

As would be understood by those of skill in the art, various methods of controlling the MFDs may be employed to control the content displayed on the MFDs. For example, the controller 130 on the display/controller 111 may be used by the pilot 210 to control the MFD 141, the on-side view 142a, and the cross-side view 143b. Similarly, the controller 130 on the display/controller 112 may be used by the copilot 220 to control the MFD 144, the on-side view 143a, and the cross-side view 142b. Alternatively, other instruments on the cockpit instrumentation 100 may be used to control the MFDs associated with the pilot or copilot.

Alternatives to the embodiment shown in FIG. 6 may include employing multi-view displays in various combinations. For example, it would be possible to employ only one multi-view display in the MFDs. The MFD 143 may be configured as the only multi-view display, effectively providing the pilot with three associated MFDs and the copilot with the typical two associated MFDs. Additionally, all of the MFDs 141, 142, 143, and 144 in the cockpit instrumentation 100 may include multi-view displays, effectively doubling the number of displays associated with the pilot 210 or copilot 220.

FIG. 6 also illustrates processors 350 and 355 which may be configured to provide image data to the display/controllers 111 and 112 and the MFDs 141, 142, 143, and 144. More specifically, the processor 350 may be configured to operate in concert with the controller 130 and/or other devices to provide image data to the multi-view display 120 of the display/controller 111, the MFD 141, the on-side view 142a of the MFD 142, and the cross-side view 143b of the MFD 143. Likewise, the processor 355 may be configured to operate in concert with the controller 130 and/or other devices to provide image data to the multi-view display 120 of the display/controller 112, the MFD 144, the on-side view 143a of the MFD 143, and the cross-side view 142b of the MFD 142. The processor 350 may monitor or receive aircraft data from the aircraft sensors 365 and process the aircraft data for display, for example, on at least one of the multi-view display 120 of the display/controller 111, the MFD 141, the on-side view 142a of the MFD 142, and the cross-side view 143b of the MFD 143. The processors 350 and 355 may also work in concert with the controllers 130 on the display/controllers 111 and 112 to control the aircraft subsystems. As a form of redundancy, the processor 355 may be configured to monitor or receive aircraft data from an additional set of aircraft sensors 370 and process the aircraft data for display.

The processor 350 may be configured to monitor or receive standby data from the separate standby information data sources 360. Similarly, the processor 355 may monitor or receive standby data from the separate standby information data sources 360. In accordance with one embodiment of the invention, the processor 350 may use the standby data and provide image data to the display/controller 111 or the MFD 142 such that the standby instrument may be displayed on a cross-side view to the copilot 220. Further, the processor 355 may use the standby data and provide image data to the display/controller 112 or the MFD 143 such that the standby instrument is displayed on a cross-side view to the pilot 210. Again, two separate standby sensors could be used instead of the single standby sensors 360 such that each processor 355 and 350 use dedicated standby information data sources.

As shown in FIG. 6, the pilot 210 may control, through the operation of the processor 350, the images shown in the display 120 of the display/controller 111, the MFD 141, the on-side view 142a, and the cross-side view 143b. Similarly, the copilot 220 may control, through the operation of processor 355, the images shown on the display 120 of the display/controller 112, the MFD 144, the on-side view 143a, and the cross-side view 142b. Although not shown, it is also contemplated that a single processor in conjunction with various aircraft sensors (standby and otherwise) may be used to control both display/controllers 111 and 112 and the MFDs 141, 142, 143, and 144. As would be apparent to those of skill in the art, other combinations of processor and sensors may be used in various combinations to provide different levels of system redundancy.

It should also be understood that embodiments of the invention may be combined with other MFD configurations. For example, an aircraft cockpit could include one, two, or three MFDs employing various combinations of multi-view displays so long as one set of views are associated with a pilot and another set of views are associated with the copilot. It should be understood that in aircraft with three or more crew members, the multi-view MFDs may be configured to direct a view at more than one crew member. Additionally, it is contemplated that a dual view display may be configured to direct each view at a different crew member, leaving the dual view display ineffective to a third crew member who is not positioned within a viewing envelop of the display. Alternatively, a multi-view display with three or more different views may be configured to direct a view at a different crew member.

As with the display/controllers, the standby instrument may be incorporated into the MFDs in order to comply with various statutory requirements, such as FAR flight regulations. For example, referring to FIG. 6, the MFDs 142 and 143 may be configured to display the standby indications on the cross-side views 142b and 143b at all times. Therefore, the cross-side views for the MFDs 142 and 143 would satisfy FAR regulations in the same manner as discuss above for display/controllers 111 and 112. The standby instrument could be incorporated into any multi-view MFD and should not be limited to the MFDs 142 and 143 shown in FIG. 6.

In accordance with another embodiment of the invention, multi-view displays may be incorporated into the MFDs 141, 142, 143, and 144, as discussed with reference to FIG. 6, in addition to the displays 120, as discussed with reference to FIG. 3. In such a configuration, a pilot or copilot may be able to select from a number of various cross-side views for display. Since multi-view displays allow one display unit to display multiple views, the multi-view displays would permit a much higher level of redundancy and flexibility. For example, in the event of a total loss of any on-side or cross-side display unit(s), a display configuration may be manually or automatically transferred to a “healthy” display or view.

Multi-view displays may be employed in the MFDs, the display/controllers, and/or other displays in the aircraft instrumentation in different combinations and arrangements. Additionally, the multi-view displays dedicated to display the standby indications on the cross-side views may be moved or customized by the pilot or copilot. For example, the pilot may choose the cross-side view on the display/controller 112 for the standby indications where, at the same time, the copilot may choose the cross-side view of the MFD 142 for the standby indications. As would be apparent to those of skill in the art, other such combinations are available and encompassed within embodiments of the invention.

Any multi-view display may be configured to default to an operating mode where the standby indications are displayed on both the on-side and cross-side views in the event of a system failure, such as a display failure. As would be apparent, any number of failures may trigger such default configuration such as the loss of a MFD, mechanical failure, loss of power, etc. As such, embodiments of the invention may provide levels of redundancy during normal flight conditions and in the event of a failure of one of the multi-view displays because both crew members, pilot and copilot, may view the standby indications on a single multi-view display, such as a display/controller or other display. It is also contemplated that any view may be configured to default back to standby indications after control of the display has gone unused for a given amount of time. For example, the aircraft menu view shown on the on-side view 111a in FIG. 5 may revert to the standby indication after the power menu goes unused for a given amount of time.

Additionally, other levels of redundancy may be built into the system with various configurations of data sources associated with redundant view displays. For example, it is contemplated that the same standby data source may be used for displaying information on the on-side and cross-side views on a single multi-view display. Alternatively, however, separate data sources may be used for each multi-view display and/or for each view in a multi-view display, significantly increasing the level of redundancy available to an aircraft instrumentation designer.

It should be understood that the on-side view and the cross-side view of any multi-view display may be configured to display information from a dedicated data source or may be configured to display information from any data source available, including the standby instrument, in the event of a system failure.

The alternative instrumentation and redundancy for the display/controllers' 111 and 112 controller functions in combination with the on-side view may allow for optional Minimum Equipment List (MEL) compliant dispatch, as required for large aircraft regulated by FAR 25/Part 91/135/121's. MEL approved aircraft may reduce down time by alleviating the need for aircraft operators to perform immediate repairs and/or by providing maximum duration of operation with a failed component. In addition to the advantages of redundancy, MEL approval is typically considered a marketing advantage for large aircraft manufactures since the operator can continue to operate when stricken in remote locations or in times of need of rapid air transport.

It should be understood that the flight deck instrumentation 100 and the embodiment of the invention shown in FIG. 3 complies with a two-pilot flight crew for a large passenger aircraft, covered for example by FAR 25.1333. However, other instrument panels for different sized aircraft may be configured in accordance with embodiments of the invention, employing display/controllers and other instrumentation displays with multi-view displays. An instrument panel employing multi-view displays may not be required or intended to function as a required regulatory standby instrument. Regardless, the multi-view displays may be incorporated into the cockpits of smaller aircraft in accordance with embodiments of the present invention.

As would be apparent to those of skill in the art, the avionic instruments for both primary and secondary displays may include a single electronic sensor package, including a navigational data source. However, the display/controllers and/or other displays may also include separate and independent electronic sensor packages for the various displays, such as the display/controllers 111 and 112, and the MFDs 141, 142, 143, and 144. This may provide the pilots with a method of verifying the accuracy and functionality of the various electronic sensor packages by comparing the information displayed on the different displays. As one of ordinary skill in the art would understand, such comparison may provide an additional level of safety and redundancy.

The menus, aircraft systems, control systems, control functions, and displays contemplated under embodiments of the invention should not be construed as limited to those examples shown in the Figures. For example, the present invention may also include, but should not be limited to, menu options and control for various aircraft systems and devices including those associated with aircraft sensors, standby flight displays, Enhanced Vision System (EVS)/Synthetic Vision System (SVS), auxiliary power units, CPDLC (Controller Pilot Data Link Communication), weather detection systems, CPCS (Cabin Pressurization Control System), fuel systems, checklist systems, primary flight display systems, map systems, Approach and Enroute Navigational Chart systems, Windows Management systems, display format memory systems, and display synoptic systems.

In accordance with alternative embodiments of the invention, multi-view displays may be employed in vehicles that require at least two crew members to operate, such as various land, water, air, and space vehicles. For example, one or more of the multi-view displays 142 and 143 from FIG. 6 may represent displays arranged in a tank, armored vehicle, boat or ship, or other vehicles. In an embodiment of the invention arranged on a tank, the on-side view 142a and the cross-side view 143b may be configured to provide vehicle or operational data to a first crew member, for example a driver or navigator. The on-side view 143a and the cross-side view 142b may be configured to provide vehicle or operational data to a second crew member, for example a gunner. Such an arrangement may provide vehicle information, such as speed, location, fuel levels, etc. to the first crew member driving the tank via the on-side view 142a and the cross-side view 143b. Information such as targeting data, vehicle location, radar signals, etc. may be provided to the second crew member operating the tank cannon via the on-side view 143a and the cross-side view 142b. As with the multi-view displays used on the aircraft, an arrangement of multi-view displays in accordance with embodiments of the invention effectively increase the available display area in typically tight quarters.

It should also be understood that the viewing envelopes may be oriented any many different directions and should not be limited to the embodiments of the invention discussed herein. For example, the designations of on-side and cross-side views, should not be limited to a horizontal arrangement, but may refer to viewing envelopes that are stacked vertically, one on top of the other, or are positioned diagonal to one another.

The foregoing descriptions of specific embodiments of the invention are presented for purposes of illustration and description. They are not intended to be exhaustive or to limit the invention to the precise forms disclosed. One skilled in the art will recognize that other changes may be made to the embodiments described herein without departing from the spirit and scope of the invention, which is defined by the claims, below.

What is claimed is:

1. A vehicle instrumentation system comprising:
a set of vehicle sensors configured to measure a plurality of vehicle data;
a processor to receive the plurality of vehicle data from the set of vehicle sensors, the processor configured to generate a first image based, at least in part, on at least one of the plurality of vehicle data and a second image based, at least in part, on at least one of the plurality of vehicle data;
a multi-view display device coupled to the processor and having a display screen mounted on a vehicle instrument panel, the display screen and processor configured to display the first image within a first viewing envelope and to display the second image within a second viewing envelope, different from the first viewing envelope;
the display screen configured to display, during operation, the first image to a first position of a first crew member located within the first viewing envelope; and
the display screen configured to display, during operation, the second image to a second position of a second crew member located within the second viewing envelope.

2. A method of controlling a vehicle using a multi-view display, the method comprising:
monitoring a plurality of vehicle data from vehicle sensors;
processing the plurality of vehicle data;
generating a first image based, at least in part, on at least one of the plurality of vehicle data;
generating a second image based, at least in part, on at least one of the plurality of vehicle data;
displaying the first image on a multi-view display within a first viewing envelope, the first image being visible to a first crew member within the first viewing envelope; and
displaying the second image on the multi-view display within a second viewing envelope, the second image being visible to a second crew member within the second viewing envelope.

3. The method of claim 2, comprising:
controlling the vehicle by the first crew member based, at least in part, on at least one of the plurality of flight data displayed to the first crew member on the first image of the multi-view display; and
controlling the vehicle by the second crew member based, at least in part, on at least one of the plurality of flight data displayed to the second crew member on the second image of the multi-view display.

4. The method of claim 3, comprising:
customizing the first image to display at least one of the plurality of vehicle data according to a preference of the first crew member; and
customizing the second image to display at least one of the plurality of vehicle data according to a preference of the second crew member.

5. The method of claim 4, wherein the vehicle is an aircraft and the plurality of vehicle data includes a plurality of flight data about the aircraft.

6. A vehicle instrumentation system comprising:
a first multi-view display configured, during operation, to display a first image visible within a first viewing envelope associated with a first crew member and a second image visible within a second viewing envelope associated with a second crew member;
a second multi-view display configured, during operation, to display a third image visible within a third viewing envelope associated with the second crew member and a fourth image visible within a fourth viewing envelope associated with the first crew member;
the first image including at least one of a plurality of vehicle data and the fourth image including at least one of the plurality of vehicle data, the first image and the fourth image being visible from a first location of the first crew member located within the first viewing envelope and the fourth viewing envelope; and
the third image including at least one of a plurality of vehicle data and the second image including at least one of the plurality of vehicle data, the third image and the second image being visible from a second location of the second crew member located within the third viewing envelope and the second viewing envelope.

7. The instrumentation system of claim 6, wherein the vehicle is an aircraft and the plurality of vehicle data includes a plurality of flight data about the aircraft.

8. The instrumentation system of claim 7, wherein:
the first multi-view display is configured to display aircraft attitude, altitude, heading, and airspeed on at least one of the first image or the fourth image at all times during operation of the aircraft; and
the second multi-view display is configured to display aircraft attitude, altitude, heading, and airspeed on at least one of the third image or the second image at all times during operation of the aircraft.

9. The instrumentation system of claim 8, wherein:
the first multi-view display is configured to display aircraft attitude, altitude, heading, and airspeed on the fourth image at all times during operation of the aircraft; and
the second multi-view display is configured to display aircraft attitude, altitude, heading, and airspeed on the second image at all times during operation of the aircraft.

10. The instrumentation system of claim 7, wherein in the event of a loss of the second multi-view display:
the first multi-view display is configured to display aircraft attitude, altitude, heading, and airspeed on the first image and on the second image at all times during operation of the aircraft.

11. The instrumentation system of claim 7, wherein in the event of a loss of the first multi-view display:
the second multi-view display is configured to display aircraft attitude, altitude, heading, and airspeed on the third image and on the fourth image at all times during operation of the aircraft.

12. A method of controlling a vehicle using multi-view displays, the method comprising:
monitoring a plurality of vehicle data from a plurality of vehicle sensors;
displaying at least one of a plurality of vehicle data in a first image, the first image being visible on a first multi-view display within a first viewing envelope, the first multi-view display coupled to at least one of the plurality of vehicle sensors;
displaying at least one of the plurality of vehicle data in a second image, the second image being visible on the first multi-view display within a second viewing envelope;
displaying at least one of the plurality of vehicle data in a third image, the third image being visible on a second multi-view display within a third viewing envelope, the second multi-view display coupled to at least one of the plurality of vehicle sensors;
displaying at least one of the plurality of vehicle data in a fourth image, the fourth image being visible on the second multi-view display within a fourth viewing envelope.

13. The method of claim 12, further comprising:
viewing by a first crew member at least one of the plurality of vehicle data on at least one of the first image or the fourth image, the first crew member positioned within the first viewing envelope and within the fourth viewing envelope; and
viewing by a second crew member at least one of the plurality of vehicle data on at least one of the third image or the second image, the second crew member positioned within the third viewing envelope and within the second viewing envelope.

14. The method of claim 13, comprising:
controlling the vehicle by the first crew member based on at least one of the plurality of vehicle data visible to the first crew member on at least one of the first image or the fourth image.

15. The method of claim 14, comprising:
controlling the vehicle by the second crew member based on at least one of the plurality of vehicle data visible to the second crew member on at least one of the third image or the second image.

16. The method of claim 15, wherein the vehicle is an aircraft and the plurality of vehicle data includes a plurality of flight data about the aircraft.

17. The method of claim 16, wherein:
displaying aircraft attitude, altitude, heading, and airspeed on the second image to the second crew member at all times during operation of the aircraft; and
displaying aircraft attitude, altitude, heading, and airspeed on the fourth image to the first crew member at all times during operation of the aircraft.

18. The method of claim 16, further comprising, in the event of a loss of the second multi-view display:
displaying aircraft attitude, altitude, heading, and airspeed on the first image at all times during operation of the aircraft; and
displaying aircraft attitude, altitude, heading, and airspeed on the second image at all times during operation of the aircraft.

19. The method of claim 17, further comprising, in the event of a loss of the first multi-view display:
displaying aircraft attitude, altitude, heading, and airspeed on the third image at all times during operation of the aircraft; and
displaying aircraft attitude, altitude, heading, and airspeed on the fourth image at all times during operation of the aircraft.

20. An aircraft instrumentation system comprising:
a first device associated with a first position of a first pilot of an aircraft, the first device being positioned within the primary field of view of the first pilot, the first device including:
a first multi-view display configured to display a first image visible within a first viewing envelope and a second image visible within a second viewing envelope; and
a first controller; and
a second device associated with a second position of a second pilot of the aircraft, the second device being positioned within the primary field of view of the second pilot, the second device including:
a second multi-view display configured to display a third image visible within a third viewing envelope and a fourth image visible within a fourth viewing envelope; and
a second controller;
wherein:
the first pilot is to be positioned, during operation of the aircraft, within the first viewing envelope and within the fourth viewing envelope; and
the second pilot is to be positioned, during operation of the aircraft, within the third viewing envelope and within the second viewing envelope.

21. The aircraft instrumentation system of claim 20, wherein:
the first controller is configured to control at least one of the first image or the fourth image; and
the second controller is configured to control at least one of the third image or the second image.

22. The aircraft instrumentation system of claim 20, wherein the first multi-view display and the second multi-view display are configured such that:
at least one of the first image or the fourth image includes the aircraft attitude, altitude, heading, and airspeed at all times during operation of the aircraft; and
at least one of the third image or the second image includes the aircraft attitude, altitude, heading, and airspeed at all times during operation of the aircraft.

23. The aircraft instrumentation system of claim 22, wherein the first multi-view display and the second multi-view display are configured such that:
the second image includes the aircraft attitude, altitude, heading, and airspeed at all times during operation of the aircraft; and
the fourth image includes the aircraft attitude, altitude, heading, and airspeed at all times during operation of the aircraft.

24. The aircraft instrumentation system of claim 23, wherein both the first image and the third image display aircraft attitude, altitude heading, and airspeed in the event of a system failure.

25. The aircraft instrumentation system of claim 20, wherein first device is mounted above a first multifunctional display (MFD) and the second device is mounted above a second MFD.

26. The aircraft instrumentation system of claim 25, wherein the first MFD and the second MFD are multi-view displays.
